(19) United States
(12) Patent Application Publication
(10) Pub. No.: US 2014/0074835 A1
(43) Pub. Date: Mar. 13, 2014

(54) METADATA ARCHITECTURE FOR INTERFACING WITH AND PROCESSING METADATA ASSOCIATED WITH DIGITAL CONTENT

(71) Applicant: Sang Bumm Han, Incheon (KR)

(72) Inventor: Sang Bumm Han, Incheon (KR)

(73) Assignee: CLO VIRTUAL FASHION INC., Seoul (KR)

(21) Appl. No.: 13/613,637

(22) Filed: Sep. 13, 2012

(51) Int. Cl. G06F 17/30

(52) U.S. Cl. 707/736; 707/E17.009

(57) ABSTRACT

Embodiments of the present invention provide an approach for interacting with and/or processing metadata associated with digital content. In a typical embodiment, various architectures are provided that may comprise interfaces, applications, processors, etc. to allow for metadata to be processed and/or appended to related main data. The architectural components herein also provide for various ways for metadata to be gathered and/or stored (e.g., provided by a user). Among other things, these approaches optimize digital and/or social media exchanges.

### TECHNICAL FIELD

In general, embodiments of the present invention relate to metadata interaction. Specifically, embodiments of the present invention relate to architectural components (e.g., processors, applications, interfaces, etc.) for interacting with and/or processing metadata related to digital content.

### BACKGROUND OF THE INVENTION

As digital content delivery continues to improve and becomes more pervasive, the need for efficient handling of associated metadata increases. Specifically, there are many different types of metadata formats. Each formatting standard typically requires dedicated programming to implement and to convert to another format. Along these lines, new metadata formats generally require a system firmware update to accommodate new formats. Such updates cannot be done in real-time and may take long periods of time to complete. Metadata is typically static and uni-directional. As such, metadata may not provide a level interactivity that is needed for digital and social media exchanges. Heretofore, the following metadata-based approaches have been attempted:

U.S. patent application No. 20110072456 discloses an Internet Protocol television (IPTV) system which includes an advertising module adapted to: read metadata information associated with an advertising item included within a content item recorded on a set-top box, determine that the advertising item is expired, and send another advertising item to the set-top box to be played on the set-top box in the place of the first advertising item when the content item is played on the set-top box.

U.S. patent application No. 20110119726 discloses a method and system which implements supplementary media channels to IPTV channels. An IPTV user may receive a selected IPTV program on an IPTV channel. The IPTV program may be correlated in time with metadata describing the content of the IPTV program.

U.S. patent application No. 20100299707 discloses a method and apparatus for receiving metadata regarding an application providing an IPTV service, in which a metadata request message for requesting metadata regarding an application providing at least one IPTV service is generated, the metadata request message is transmitted to a second entity apparatus, and a metadata response message including the metadata regarding the application providing the at least one IPTV service is received from the second entity apparatus, in response to the metadata request message.

U.S. patent application No. 20100154015 discloses a metadata search apparatus using speech recognition which includes a metadata processor for processing contents metadata to obtain allomorph of target vocabulary required for speech recognition and search.

U.S. patent application No. 20090241154 discloses a method of processing data in an IPTV receiver. The method includes receiving location information necessary to acquire a content corresponding to a content reference identifier (CRID) by using the CRID.

U.S. patent application No. 20090198656 discloses an IPTV which collects content information from content providers and a method and system for providing the IPTV with the content information are provided. The IPTV includes a connection unit which enables the IPTV to be connected to the Internet for data transmission or reception over the Internet, a content information collection unit which collects information about content created by IPTV content providers over the Internet, and a content information processing unit which creates standard metadata by processing the collected content information.

U.S. patent application No. 20090193483 discloses a method and apparatus for limiting a content usage authority scope of a client by using metadata in an IPTV service. The method performed by a metadata server adds control information to the metadata and transmits the metadata, wherein the content usage authority scope of the client is defined in the control information.

U.S. Pat. No 8,165,449 discloses a set of interfaces, data structures and events represent a digital video (DV) metadata extraction tool. The DV metadata extraction tool includes an application programming interface (API) for describing DV metadata packs that are to be extracted from a DV data stream.

Unfortunately, none of the existing approaches provide for interaction and/or processing of metadata.

### SUMMARY

In general, embodiments of the present invention provide an approach for interacting with and/or processing metadata associated with digital content. In a typical embodiment, various architectures are provided that may comprise interfaces, applications, processors, etc. to allow for metadata to be processed and/or appended to related main data. The architectural components herein also provide for various ways for metadata to be gathered and/or stored (e.g., provided by a user). Amont other things, these approaches optimize digital and/or social media exchanges.

A first aspect of the present invention provides a metadata processing architecture for digital content, comprising: a main data processor being configured to receive and process main data associated with digital content; a metadata processor being configured to receive and process metadata related to the main data; and a main-to-meta data (MMD) interface coupling the main data processor to the metadata processor, the MMD interface being configured to communicate the metadata from the metadata processor to the main data processor.

A second aspect of the present invention provides a metadata processing architecture for digital content, comprising: a metadata processor comprising a metadata application for processing metadata and main data associated with the digital content; an external interface coupled to the metadata application for facilitating interactions with the metadata process by a user; and a main data interface coupled to the metadata application for receiving the main data.

A third aspect of the present invention provides a method for processing metadata, comprising: receiving a set of main data related to digital content in a main data processor; receiving a set of metadata related to the main data in a metadata processor; communicating the set of metadata to the main data processor from the metadata processor via a main-to-metadata (MMD) interface; and processing the main data based on the set of metadata.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing node according to an embodiment of the present invention.

FIG. 2 depicts a system/architectural diagram comprising a main-to-metadata (MMD) according an embodiment of the present invention.

FIG. 3 depicts a system/architectural diagram comprising a user metadata server according an embodiment of the present invention.

FIG. 4 depicts a system/architectural diagram comprising a set-top box (STB) according an embodiment of the present invention.

FIG. 5 depicts a system/architectural diagram comprising a metadata processor coupled to various interfaces according an embodiment of the present invention.

FIG. 6 depicts a system/architectural diagram comprising a metadata processor coupled to various interfaces and a main data processor according an embodiment of the present invention.

FIG. 7 depicts a system/architectural diagram comprising multiple metadata processors and external service servers according an embodiment of the present invention.

FIG. 8 depicts a system/architectural diagram comprising multiple metadata processors and STBs according an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The word “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Embodiments of the present invention provide an approach for interacting with and/or processing metadata associated with digital content. In a typical embodiment, various architectures are provided that may comprise interfaces, applications, processors, etc. to allow for metadata to be processed and/or appended to related main data. The architectural components herein also provide for various ways for metadata to be gathered and/or stored (e.g., provided by a user). Amont other things, these approaches optimize digital and/or social media exchanges.

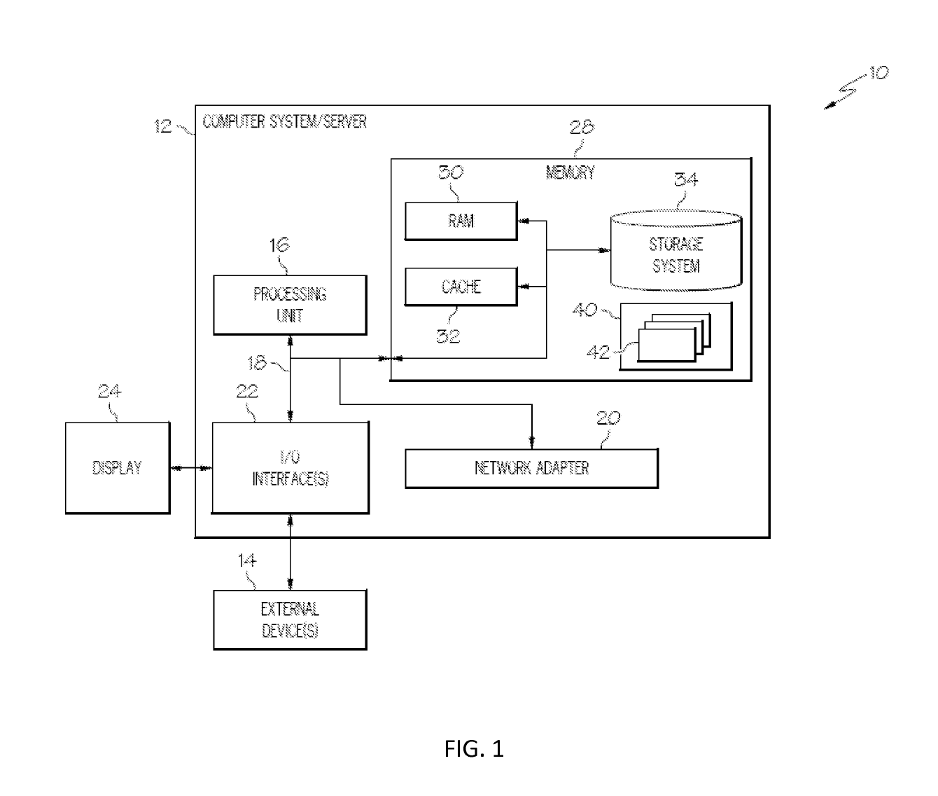

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth herein. That is computing node 10 may comprise any combinations of hardware (processors) and/or software (e.g., engines, applications, etc.) capable of receiving, storing, interacting with, and/or processing metadata associated with content (e.g., digital content).

In computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, mobile devices, global positioning systems (GPS), GPS-enable devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on, which perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Metadata interaction program/utility 40, having a set (at least one) of program modules 42, may be stored in memory 28 by way of example, and not limitation, as well as an operating system, one or more application programs, other program modules, and program data. In general, metadata interaction 40 may performs or assist in performing the function of the present invention as described herein. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

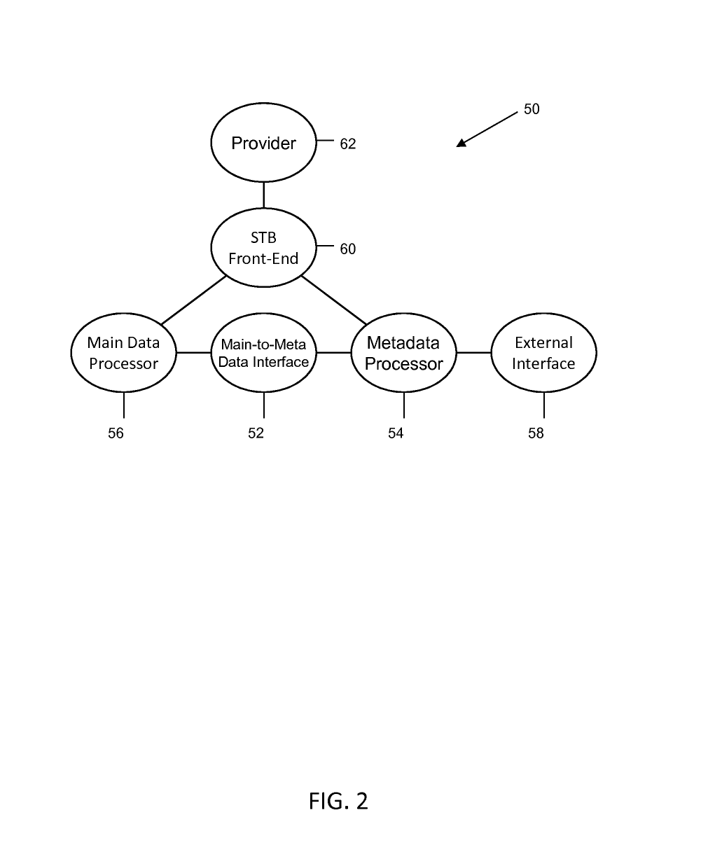

It is understood that FIG. 1 is intended to provide one possible embodiment for implementing on or more of the teachings recited herein. Along these lines, it is understood that any of the architectures of FIGS. 2-8 (or any of the components therein such as processors, interfaces, applications, etc.) may be implemented using any of the teachings of FIG. 1. In any event, aspects of the present invention may provide the following: a metadata interface to main data and middleware; the capability for users to generate his/her own metadata; execution of script-based service applications in active and client modes; collaboration with external agents to facilitate advanced services; media identification using metadata; and/or enablement of metadata service extensions and plug-ins.

Referring now to FIG. 2, a system/architecture 50 according to an embodiment of the present invention. As depicted, architecture comprises main-to-metadata (MMD) interface 52 coupled to a metadata processor 54 (for processing metadata and which itself is coupled to an external interface 58), and a main data processor 56 (for processing main data). Coupled to metadata processor 54 and main data processor 56 is STB front end component 60, which may receive digital content from a one or more providers 62. In general, metadata (e.g., related to digital content and/or main data associated therewith) is received by metadata processor 54 and fed to main data processor 56 via MMD interface 52. Upon receiving the metadata, main data processor 56 will modify and/or append the main data based on the metadata. Such metadata may be received from a content source, provider 62, and/or a user (via external interface 58). Moreover, metadata processor 54 may access main data before or after the main data has been processed (e.g., based on the metadata) processing via MMD interface 52.

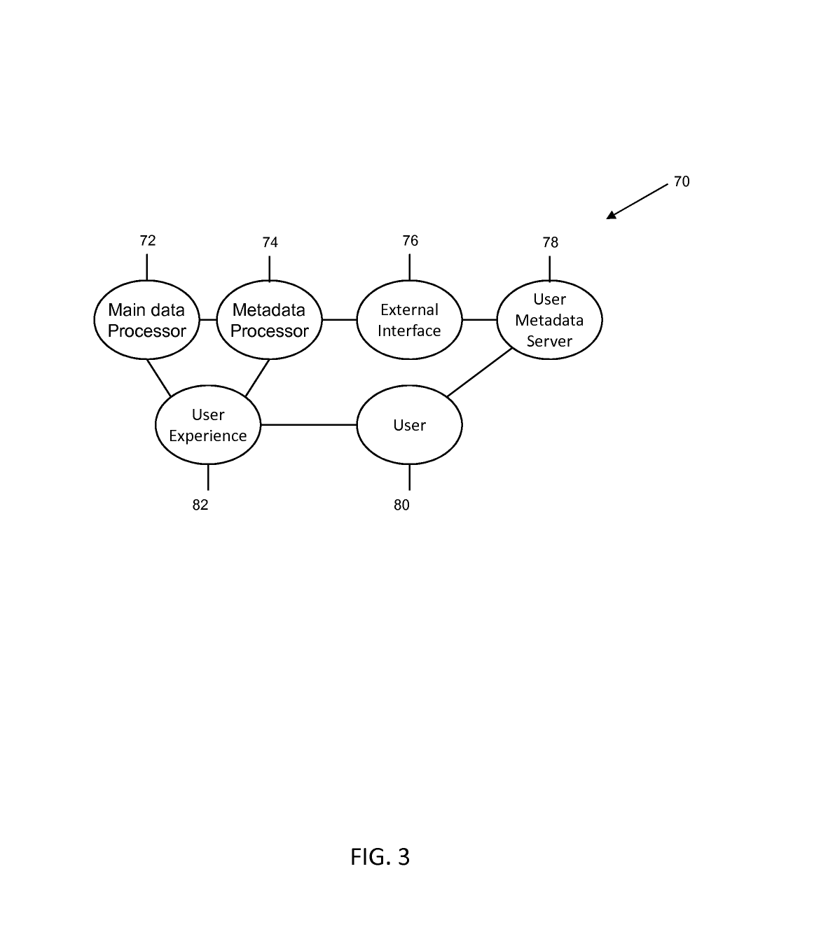

Referring now to FIG. 3, another system/architecture 70 according to an embodiment of the present invention is shown. As depicted, architecture may comprise a main data processor 72 coupled to metadata processor 74, which itself is coupled to external interface 76. Coupled to main data professor 72 and metadata processor 74 is user experience component 82. As further depicted, user 80 may provide metadata to metadata processor 74 via external interface 76. Moreover, such metadata may be stored in user metadata server 78. User experience component 82 will permit user 80 to interact with processed main data and/or processed metadata.

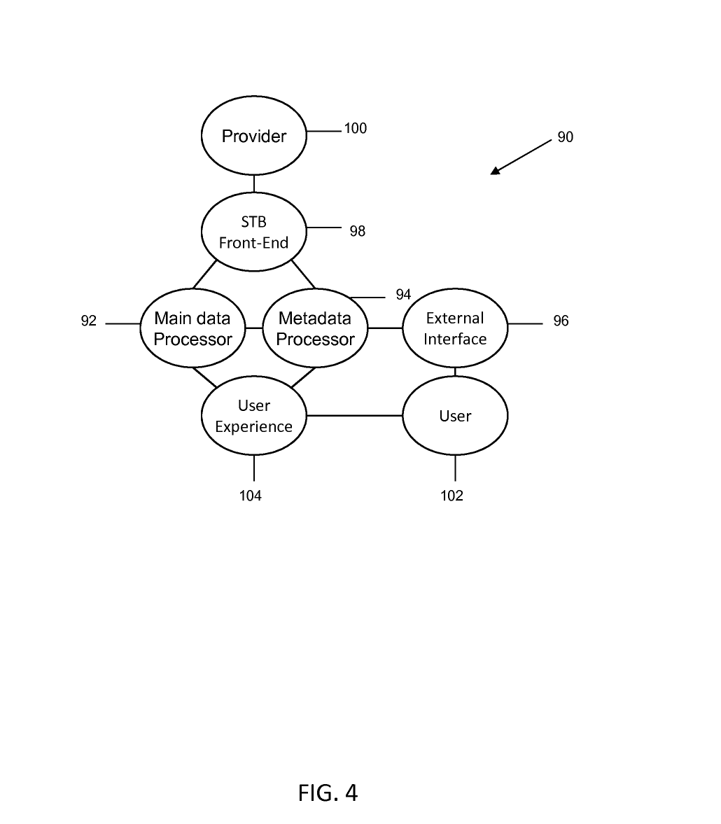

FIG. 4 depicts a similar system/architecture 90 is shown that may comprise a main data processor 92 coupled to metadata processor 94, which itself is coupled to external interface 96. Coupled to main data professor 92 and metadata processor 94 is user experience component 104. As further depicted, user 102 may provide metadata to metadata processor 94 via external interface 96. As further shown, main data and/or metadata may be provided for processing by main data processor 92 and/or metadata processor 94 by a provider 100 via STB 98. Similar to system/architecture 70, user experience component 104 may permit user 102 to interact with processed main data and/or processed metadata.

Thus, system/architecture 70 and/or system/architecture 90 allows a user to create his/her own metadata based on the user experience. External interface 76 allows the user to store metadata to a user's metadata server 78. Alternatively, provider 100 can act as a metadata server. In any of the embodiments discussed herein, metadata type may include text, audio, a user's own video, live streaming, hyperlinks, etc. with relative time stamps.

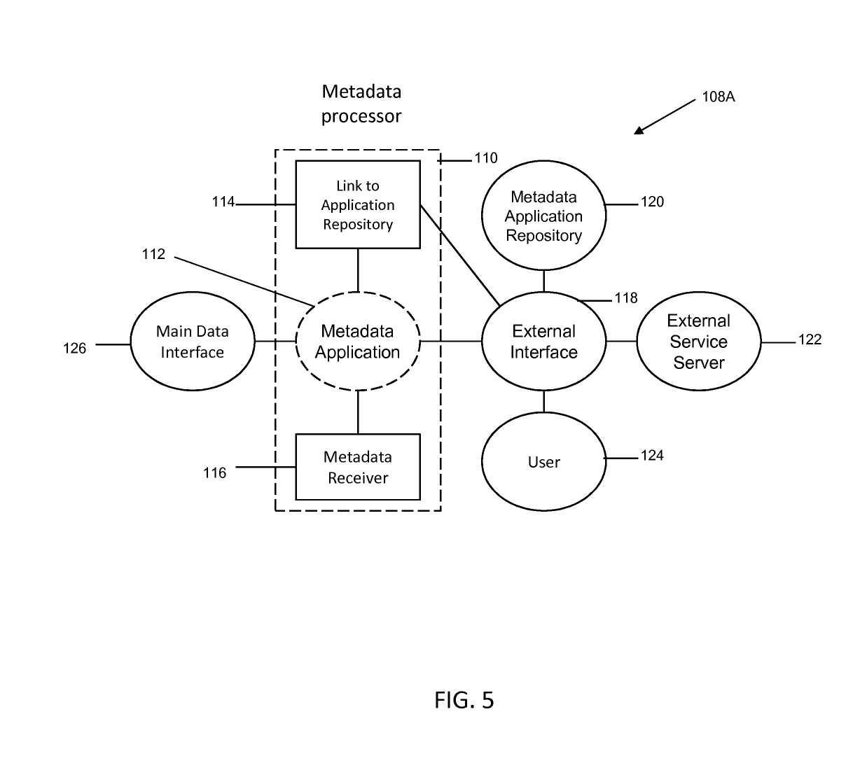

Referring now to FIG. 5, a system/architecture 108A according to another embodiment of the present invention is shown. As depicted, system/architecture 108A may comprise a metadata processor 110 comprising a metadata application 112, which is coupled to a link to application repository 114 and a metadata receiver 116. As further shown, metadata application is also coupled to external interface 118 and a main data interface 126. External interface 118 is coupled to metadata application repository 120, external service server 122 and user 124. Still yet, metadata application 112 may be obtained from repository 120 via communication through link 114 and external interface 118.

In general, metadata processor 110 may host: a service pipeline/channel through external interface 118; and/or a plug-in or extension run either at metadata processor 110 and/or external service server 122. In a typical embodiment, a service and/or metadata application 112 may access main data for processing. In such an embodiment, multiple modes are possible: For example, an active mode may be implemented in which metadata processor 110 handles some or all of data processing functions. Alternatively, a passive mode may be implemented in which external service server 122 receives some or all of the data and metadata application 112 acts as a communications pipe pipeline/channel. Along these lines, any implemented service application may run/execute network services such as: push notifications to imitate other terminal clients; update services such as updating metadata processing schemes and the metadata itself in real-time; etc.

Under one or more of the embodiments described herein, a user may send metadata for a search (e.g., a fingerprint) to an external search engine. Under such a feature, the media identity may be matched for further processing. For time sensitive metadata, media time/domain information may be used for search and processing. Still yet, other alternative metadata (e.g., preferred by the user) may be served to user's metadata processor. For a more detailed/deeper search, main data may be forwarded to the external service agent. Along similar lines, voice data, music data, facial recognition data, object recognition data, and/or related analyses may be implemented by the metadata processor and/or the external media server.

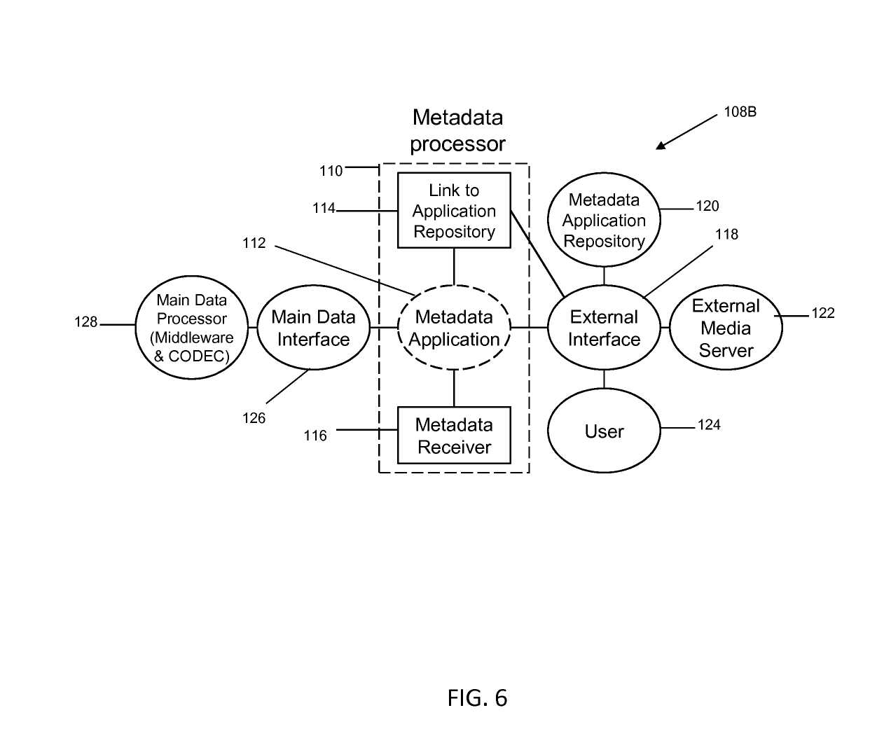

Referring now to FIG. 6, system/architecture 108B according to another embodiment of the present invention is shown. As depicted, system/architecture 108B may comprise a metadata processor 110 comprising a metadata application 112, which is coupled to a link to application repository 114 and a metadata receiver 116. As further shown, metadata application is also coupled to external interface 118 and a main data interface 126. External interface 118 is coupled to metadata application repository 120, external service server 122 and user 124. Still yet, metadata application 112 may be obtained from repository 120 via communication through link 114 and external interface 118. Under system/architecture 108B, main data interface 126 is coupled to main data processor (e.g., middleware and CODEC).

In general, systems/architectures 108A and/or 108B provide (among other things) access to an external service/media server 122. Along these lines, the external media server 122 may be part of a provider's infrastructure, and/or the external media server 122 may operated and/or affiliated with a different service provider. In a typical embodiment, the metadata processor 110 (e.g., metadata application 112) forwards media data (e.g., data streams) to the main data processor 128 through the main data interface 126. The external media source/server 122 may comprise another metadata processor that may run on a STB, mobile platform, etc. Another user's STB metadata processor may provide user-created metadata including text, audio, and video in real-time, through external interface 118.

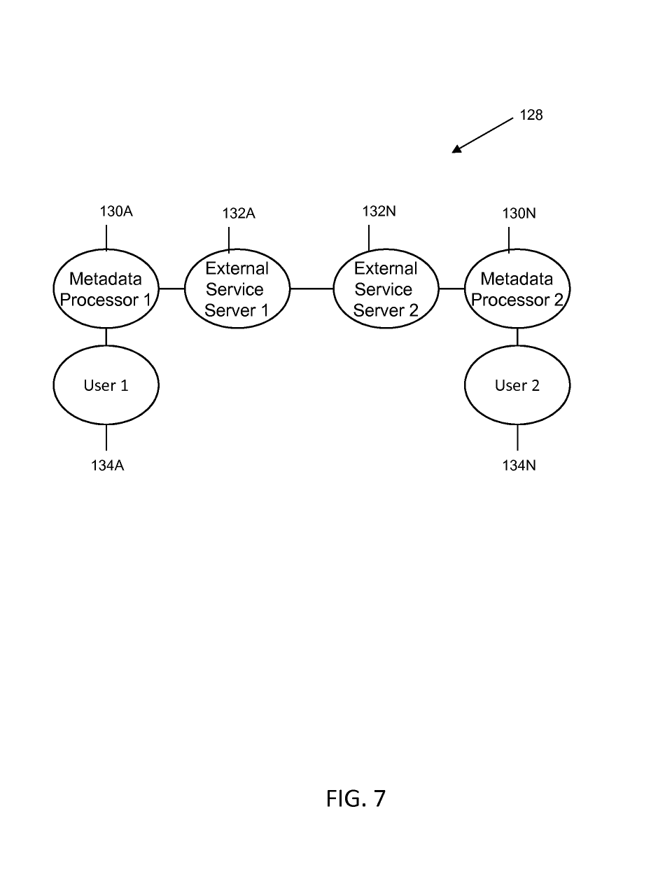

Referring now to FIG. 7, system/architecture 128 according to another embodiment of the present invention is shown. As depicted, system/architecture 128 may comprise a set of metadata processors 130A-N, which is each coupled to a set of interconnected external service servers 132A-N. A set of users 134A-N may interact with metadata processors 130A-N. In general, metadata processors 130A-N, external service servers 132A-N may form a storage and service cloud that may include metadata converter(s), metadata application(s), metadata, etc. Along these lines, a user may be provided with an aggregate of metadata from a group of users and/or nodes. Under a cloud computing implementation, cloud service(s) may be integrated with social media services for further data linkage and flow.

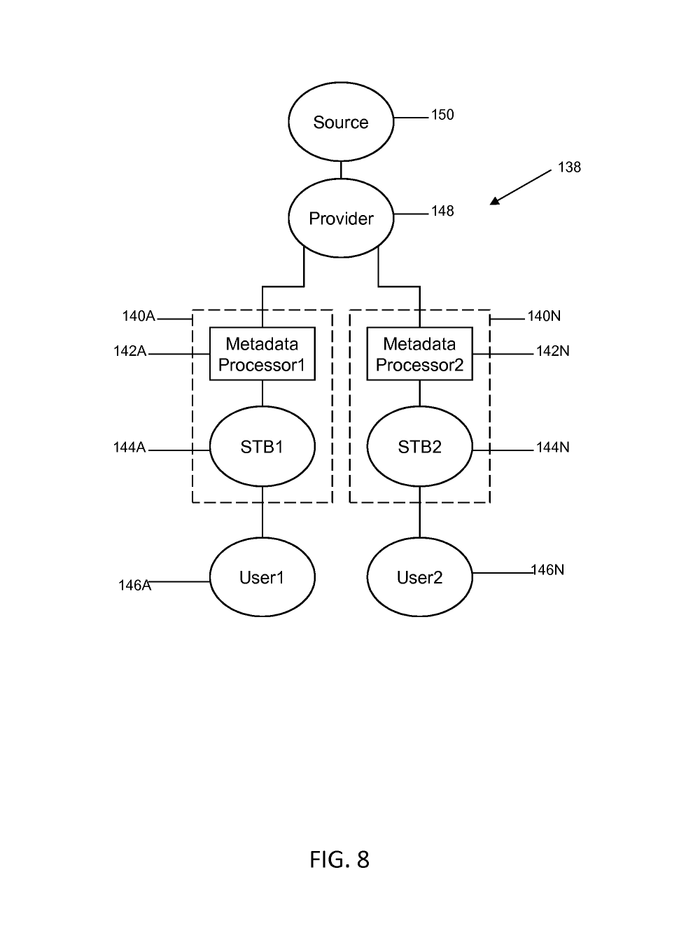

Referring now to FIG. 8, system/architecture 138 according to another embodiment of the present invention is shown. As depicted, system/architecture 128 may comprise a set of processing units 140A-B that each comprises a metadata processor 142A-N coupled to a STB 144A-N. As further shown, content may flow from a source 150 to a content provider 148, through processing units 140A-N (where the main data and metadata associated with/related to the digital content may be processed), and then on to users 146A-N.

Under such an embodiment, the metadata processors 142A-N allow for backward metadata aggregation by provider 148 and/or source 150. This information may be hierarchically managed to allow selective sets are forwarded. Essential metadata sets defined at each level may be sent backward to a previous metadata source. Moreover, essential metadata sets may be is determined by legal, monetary transaction necessity, customary limits, etc. Non-essential metadata processor information may optional for the users, subject to the users' application agreements, etc.

In general, the various embodiments discussed and described herein provide approaches/methods for interfacing main data to middleware platform whereby: a user may generate his/her own metadata; media unique identification may be established using metadata; script-based service applications may be run in active and/or client modes; collaboration with external agents to facilitate advanced services may be enabled. Still yet, these embodiments provide approaches/methods for enabling metadata service extensions and/or plug-ins.

While shown and described herein as a metadata interaction solution, it is understood that the invention further provides various alternative embodiments. For example, in one embodiment, the invention provides a computer-readable/useable medium that includes computer program code to enable a computer infrastructure to provide metadata interaction as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (Fig. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide metadata interaction functionality. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for metadata interaction conversion. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

1. A metadata processing architecture for digital content, comprising:
a main data processor being configured to receive and process main data associated with digital content;
a metadata processor being configured to receive and process metadata related to the main data; and
a main-to-meta data (MMD) interface coupling the main data processor to the metadata processor, the MMD interface being configured to communicate the metadata to be integrated into the main data from the metadata processor to the main data processor.

2. The metadata processing architecture of claim 1, further comprising an external interface coupled to the metadata processor.

3. The metadata processing architecture of claim 2, the external interface being configured to receive the metadata from a user.

4. The metadata processing architecture of claim 3, the metadata being received by the external interface from the user via a user metadata server.

5. The metadata processing architecture of claim 1, further comprising a set-top box (STB) component coupled to at least one of the main data processor or the metadata processor.

6. The metadata processing architecture of claim 5, the main data being received via the STB component from a content provider.

7. The metadata processing architecture of claim 1, the main processor being further configured to receive the metadata data from the metadata processor and to append the metadata to the main data.

8. A metadata processing architecture for digital content, comprising:
a metadata processor comprising a metadata application for processing metadata and main data associated with the digital content;
an external interface coupled to the metadata application for facilitating interactions with the metadata process by a user; and
a main data interface coupled to the metadata application for receiving the main data and interfacing the main data to a middleware platform containing the metadata processor.

9. The metadata processor of claim 8, further comprising a link to an application repository coupled to the metadata application and the external interface.

10. The metadata processor of claim 8, further comprising a metadata receiver coupled to the metadata application for exchanging the metadata from the metadata application.

11. The metadata processor of claim 8, further comprising a metadata application repository coupled to the external interface for providing or managing the metadata application.

12. The metadata processor of claim 8, further comprising an external service server coupled to the metadata processor for providing external services to the metadata processor via the external interface.

13. The metadata processor of claim 8, further comprising a main data processor coupled to the main data interface for receiving and processing the metadata data from the metadata processor.

14. A method for processing metadata, comprising:
receiving a set of main data related to digital content in a main data processor;
receiving a set of metadata related to the main data in a metadata processor;
communicating the set of metadata to be integrated into the main data to the main data processor from the metadata processor via a main-to-metadata (MMD) interface; and
processing the main data based on the set of metadata.

15. The method of claim 14, the set of metadata being received from a user via an external interface.

16. The method of claim 15, the external interface being coupled to the metadata processor.

17. The method of claim 15, further comprising storing the set of metadata in a user metadata server.

18. The method of claim 14, the set of metadata comprising at least one of the following: text data, audio data, video data, or hyperlinks.

19. The method of claim 14, the set of main data being received by the main data processors from at least one content provider.

20. The method of claim 14, the set of main data being received from the at least one content provider via at least one set-top box (STB).
